(19) United States
(12) Patent Application Publication
(10) Pub. No.: US 2009/0129198 A1
(43) Pub. Date: May 21, 2009

(54) INTRA-MICROCHANNEL MIXING METHOD AND APPARATUS

(76) Inventors: Hideyuki KARAKI, MInami-Ahigara-shi (JP); Kota Kato, Minami-Ahigara-shi (JP); Yoshihiro Sawayashiki, Minami-Ahigara-shi (JP); Hiroki Terada, Minami-Ahigara-shi (JP); Akira Wakabayashi, Minami-Ahigara-shi (JP)

Correspondence Address: BIRCH STEWART KOLASCH & BIRCH, PO BOX 747, FALLS CHURCH, VA, 22040-0747, US

(21) Appl. No.: 12/270,606

(22) Filed: Nov. 13, 2008

(30) Foreign Application Priority Data
Nov. 15, 2007 (JP) P2007-297001

(51) Int. Cl. B01F 15/06

(52) U.S. Cl. 366/145

(57) ABSTRACT

An intra-microchannel mixing method for mixing at least two substances in a microchannel is provided, the method including: at least one minute channel; and a first area and a second area which are contiguous with each other, the method comprising: accommodating the at least two substances in the at least one minute channel; and regulating the first area and the second area to different temperatures.

### BACKGROUND OF THE INVENTION

1. Field of the Invention

This invention relates to an intra-microchannel mixing method and apparatus and in particular to an intra-microchannel mixing method and apparatus of a liquid reagent for analyzing a biosubstance of blood, etc.

2. Description of the Related Art

The recent progress of molecular biology has indicated that the effect of medicine administration in disease treatment and an individual difference of a side effect caused by a constitutional predisposition can be predicted by analyzing a biosubstance of blood, etc., and using this, there has been a growing trend to conduct optimum treatment for each individual. For example, if it is known that there is strong correlation between a specific gene and the effect and side effect of a specific curative medicine, to make the information useful for treatment of a specific patient, the base sequence of the genes of the patient needs to be known. Gene diagnosis to obtain information concerning variation in endogenous genes or monobasic polymorphism (SNP) can be conducted by amplification and detection of a target nucleic acid containing such variation or monobasic polymorphism. Thus, a simple and easy method capable of amplifying and detecting the target nucleic acid in a sample rapidly and precisely is demanded.

Particularly, nucleic acid amplification reaction using a PCR (Polymerase Chain Reaction) method is a basic technology in the biotechnology field. The PCR method is a method of performing temperature regulation of a reaction liquid of a mixture of template DNA, a primer, a substrate, a heat resistant polymerase enzyme, etc., and changing the reaction liquid to predetermined three types of temperatures in sequence repeatedly, thereby amplifying the target DNA. Specifically, the temperature of the reaction liquid is regulated to a temperature to conduct denaturation reaction for dissociating double stranded DNA to single-stranded DNA and subsequently is regulated to a temperature to conduct annealing reaction for associating a primer with the single-stranded DNA and further subsequently is regulated to a temperature to conduct double stranded elongation reaction using a heat resistant polymerase enzyme. Thus, the temperature of the reaction liquid is regulated to three steps of temperatures in sequence, whereby DAN can be amplified.

As this kind of art, for example, in a microfluid element having a soluble substance adhesion channel and a use method of the microfluid element disclosed in Japanese Patent Laid-Open No. 2004-194652, a method of previously carrying a dry reagent carried with a soluble substance as a carrier in a channel of the microfluid element and introducing an inspected liquid, thereby dissolving and mixing the dry reagent is disclosed. In a microchemical device and a manufacturing method of the microchemical device disclosed in Japanese Patent Laid-Open No. 2006-133003, a manufacturing method of joining a substrate and a substrate with a dry reagent carried thereon to produce a microchemical device is disclosed.

In an agitator and an agitation method using the agitator disclosed in Japanese Patent Laid-Open No. 2006-145451, a chamber of a shape wherein a capillary force does not occur and a channel of a shape wherein a capillary force occurs are provided so as to communicate with each other and a centrifugal force and a capillary force are caused to act alternately on a poured liquid, thereby transporting the liquid reciprocatedly between the chamber and the channel and agitating a small amount of liquid. Further, in a microchip and a liquid mixing method and a blood examination method using the microchip disclosed in Japanese Patent Laid-Open No. 2007-121275, a method of providing a channel wherein a first channel part having a large cross-sectional area and a second channel part having a small cross-sectional area are placed alternately and efficiently mixing liquids different in viscosity, specific gravity, volume ratio by the liquid diffusion action in the first channel part when liquid is transported in the channel is disclosed.

### SUMMARY OF THE INVENTION

However, if an inspected liquid is allowed to flow into the microchannel and is simply brought into contact with the substance carried in the microchannel, dissolution of the substance for preliminary treatment or reaction treatment for analysis into a sample is slow and the treatment is delayed; this is a problem. It is also feared that the analysis results, etc., may vary because the dissolved substance for preliminary treatment or reaction treatment for analysis does not sufficiently diffuse into the sample and mixing of the substance for preliminary treatment or reaction treatment for analysis and the sample does not become uniform.

Then, if an attempt is made to apply the mixing method described above to allow an inspected liquid to flow into the microchannel and dissolve and mix the substance carried in the microchannel, particularly when dissolving and mixing are performed at more than one point at the same time, the channel configuration and liquid delivery control for transporting liquid in each case become necessary and it is feared that a microfluid chip and a controller may become complicated and impracticable.

It is therefore an object of the invention to provide an intra-microchannel mixing method and apparatus capable of promoting mixing of at least two mixed substances of a sample and a reaction treatment substance for preliminary treatment and analysis in a microchannel and providing a uniform mixed state in a shorter time, the intra-microchannel mixing method and apparatus which can be applied to mixing treatment in a microchannel chip so that analytical processing in the microfluid chip can be speeded up and the accuracy of the analytical processing can be improved in a simple configuration.

The above-mentioned object according to the invention can be accomplished according to the following configuration.

(1) An intra-microchannel mixing method for mixing at least two substances in a microchannel including: at least one minute channel; and a first area and a second area which are contiguous with each other, the method comprising:

accommodating the at least two substances in the at least one minute channel; and

regulating the first area and the second area to different temperatures.

According to the intra-microchannel mixing method, the first area and the second area contiguous with each other are regulated to different temperatures in a part of the microchannel, whereby convection occurs in the mixed substances between the first area and the second area. As the mixed substances are moved because of the convection, agitating of the mixed substances advances and the mixed substances can be mixed efficiently in the narrow microchannel.

(2) The intra-microchannel mixing method as described in (1) above,

wherein the at least one minute channel has at least one chamber part having an enlarged cross-sectional area compared with that of the at least one minute channel, and

the at least two substances are mixed in the at least one chamber part.

According to the intra-microchannel mixing method, a chamber part having a comparatively large cross-sectional area is provided and the mixed substances are mixed in the chamber part, whereby a round volume of the mixed substances can be efficiently mixed at a time.

(3) The intra-microchannel mixing method as described in (2) above,

wherein the first area and the second area are areas each constitutes a bottom face of the at least one chamber part, and

a temperature of the at least two substances in the at least one chamber part is regulated from the bottom face.

According to the intra-microchannel mixing method, to heat the mixed substances in the chamber part, the mixed substances are heated from the bottom face of the chamber part, whereby convection can be caused efficiently to occur in the chamber part. Accordingly, the agitating effect of the mixed substances can be enhanced for efficiently mixing the mixed substances.

(4) The intra-microchannel mixing method as described in any one of (1) to (3) above,

wherein the microchannel includes: a plurality of the minute channels; and a common channel communicating with one end of each of the plurality of the minute channels, and

wherein the at least two substances are supplied from the common channel to each of the plurality of the minute channels.

According to the intra-microchannel mixing method, the mixed substances are supplied to each of a plurality of the microchannels, whereby they can be dissolved and mixed in the microchannels at the same time. The microchannels can be treated under the same condition and the analysis accuracy can be improved. Further, the mixed substances are dissolved and mixed at more than one point, so that analytical processing can be speeded up and can be performed efficiently.

(5) An intra-microchannel mixing apparatus for mixing at least two substances in a microchannel, the apparatus comprising:

a microchannel that includes: at least one minute channel; and a first area and a second area which are contiguous with each other;

a first temperature regulation unit that regulates a temperature of the first area;

a second temperature regulation unit that regulates a temperature of the second area; and

a control unit that is capable of setting the first temperature regulation unit and the second temperature regulation unit to different temperatures.

According to the intra-microchannel mixing apparatus, for the first area and the second area contiguous with each other, the first temperature regulation unit for regulating the temperature of the first area and the second temperature regulation unit for regulating the temperature of the second area are set to different temperatures by the control unit, whereby convection can be caused efficiently to occur in the mixed substances between the first area and the second area. Accordingly, the agitating effect of the mixed substances can be enhanced for efficiently mixing the mixed substances in the narrow microchannel.

(6) The intra-microchannel mixing apparatus as described in (5) above,

wherein the at least one minute channel has at least one chamber part having an enlarged cross-sectional area compared with that of the at least one minute channel, and

the at least two substances are mixed in the at least one chamber part, and

wherein the first temperature regulation unit and the second temperature regulation unit are placed facing the at least one chamber part.

According to the intra-microchannel mixing apparatus, heating to one side is performed in the chamber part having a comparatively large cross-sectional area by the first temperature regulation unit and the second temperature regulation unit, whereby convection can be caused efficiently to occur in the mixed substances in the chamber part and a round volume of the mixed substances can be mixed at a time by the agitating effect.

(7) The intra-microchannel mixing apparatus as described in (5) or (6) above,

wherein the first area and the second area are roughly equal in area.

According to the intra-microchannel mixing apparatus, the first area and the second area are roughly equal in area, so that the convection speed is increased and the agitation efficiency is improved.

(8) The intra-microchannel mixing apparatus as described in any one of (5) to (7) above,

wherein the first temperature regulation unit and the second temperature regulation unit each comprises:

a heating section that heats the at least one minute channel; and

a temperature measuring section that measures a temperature of the at least one minute channel,

wherein a heating amount of the heating section is regulated in response to a measurement temperature by the temperature measuring section.

According to the intra-microchannel mixing apparatus, the first temperature regulation unit and the second temperature regulation unit include a heating section and a temperature measuring section, and the heating amount of the heating section is regulated in response to the measurement temperature of the temperature measuring section, so that the first area and the second area can be set to any desired temperatures and accordingly the convection speed of the mixed substances can be controlled for efficiently mixing the mixed substances.

(9) The intra-microchannel mixing apparatus as described in any one of (5) to (8) above,

wherein the microchannel includes: a plurality of the minute channels; and a common channel communicating with one end of each of the plurality of the minute channels, and

wherein the at least two substances are supplied from the common channel to each of the plurality of the minute channels.

According to the intra-microchannel mixing apparatus, the mixed substances are supplied from the common channel to each of the microchannels, whereby they can be dissolved and mixed in the microchannels at the same time. The microchannels can be treated under the same condition and the analysis accuracy can be improved. Further, the mixed substances are dissolved and mixed at more than one point, so that analytical processing can be speeded up and can be performed efficiently.

(10) The intra-microchannel mixing apparatus as described in any one of (5) to (9) above,

wherein the at least two substances contain: a liquid reagent; and a soluble solid, and

the soluble solid is previously fixed in an inside of the microchannel.

According to the intra-microchannel mixing apparatus, the mixed substances contain a liquid reagent and a soluble solid and this soluble solid is previously fixedly secured to the inside of the microchannel, so that the liquid reagent is convected in the microchannel, whereby the soluble solid can be dissolved efficiently and can also be mixed uniformly.

According to the intra-microchannel mixing method of the invention, the first area and the second area contiguous with each other are regulated to different temperatures, whereby convection is forcibly caused to occur in the mixed substances between the first area and the second area for agitating the mixed substances, and the mixed substances can be uniformly mixed efficiently in a short time in the narrow microchannel.

According to the intra-microchannel mixing apparatus of the invention, the control unit sets the first temperature regulation unit for regulating the temperature of the first area and the second temperature regulation unit for regulating the temperature of the second area to different temperatures, whereby convection can be caused to occur in the mixed substances efficiently between the first area and the second area, whereby the agitating effect of the mixed substances can be improved and the mixed substances can be uniformly mixed efficiently in the narrow microchannel. If the intra-microchannel mixing apparatus is applied to the mixing treatment in a microfluid chip, analytical processing in the microfluid chip can be speeded up and the accuracy of the analytical processing can be improved.

### BRIEF DESCRIPTION OF THE DRAWINGS

FIG. 1 is a block diagram of a sample analysis system according to a first exemplary embodiment of the invention;

FIG. 2A is a plan view of a microfluid chip retention section in FIG. 1 and FIG. 2B is a sectional view taken on line A-A in FIG. 2A;

FIGS. 3A to 3C are sectional views taken on line A-A in FIG. 2A; FIG. 3A is a conceptual drawing to show a state at the liquid delivering time; FIG. 3B is a conceptual drawing to show a state at the agitating time; and FIG. 3C is a conceptual drawing to show a state at the reaction processing time;

FIG. 4 is a main part enlarged view of FIG. 3B;

FIG. 5 is a plan view of a microfluid chip retention section of another embodiment of the invention;

FIG. 6 is a block diagram to represent a microfluid chip according to a second exemplary embodiment of the invention together with the schematic configuration of a sample analysis system;

FIG. 7 is an exploded perspective view of the microfluid chip shown in FIG. 6;

FIGS. 8A and 8B are plan views of the microfluid chip shown in FIG. 7 wherein FIG. 8A is a top view and FIG. 8B is a bottom view;

FIG. 9 is an enlarged view of FIG. 8B; and

FIG. 10 is an enlarged view of a reaction section in FIG. 9.

### DETAILED DESCRIPTION OF THE INVENTION

### First Embodiment

A first preferred embodiment of an intra-microchannel mixing apparatus according to the invention will be discussed in detail with reference to the accompanying drawings. An intra-microchannel mixing apparatus formed as a part of a sample analysis system will be discussed as one example of the intra-microchannel mixing apparatus.

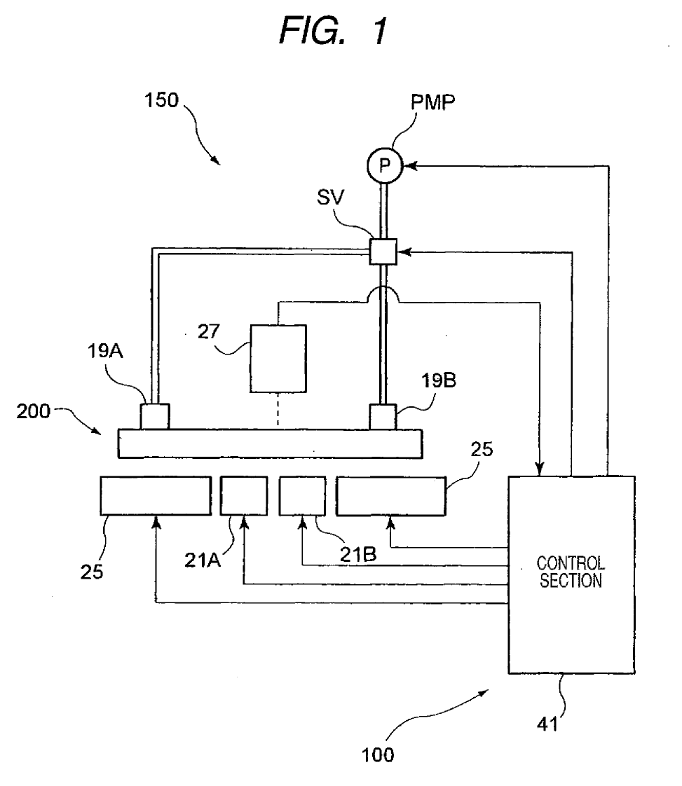

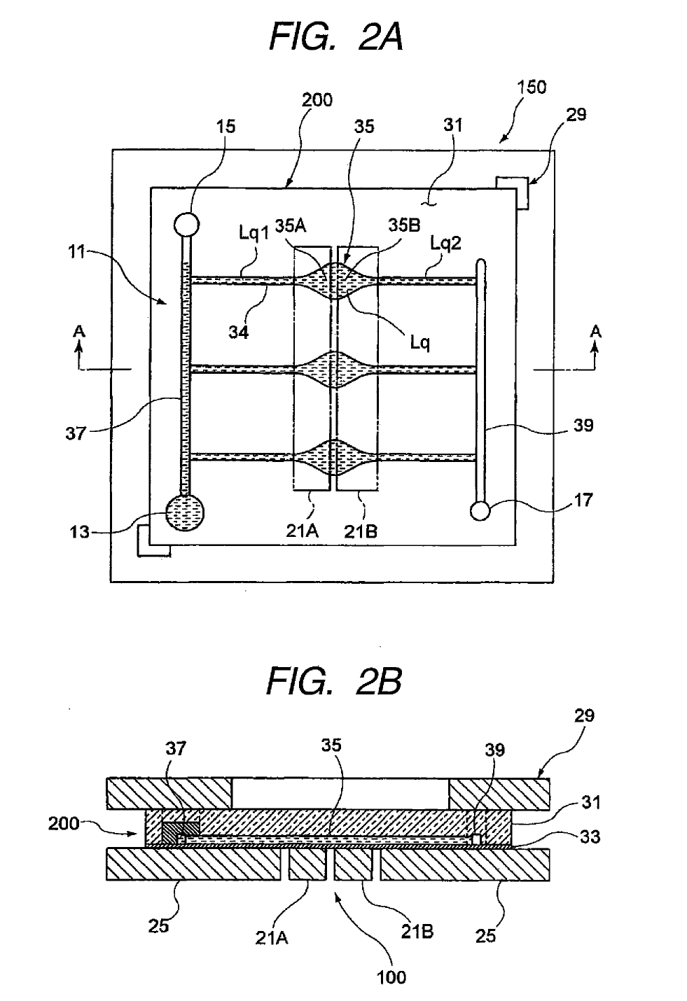

FIG. 1 is a block diagram of a sample analysis system according to the first preferred embodiment of the invention and FIG. 2A is a plan view of a microfluid chip retention section and FIG. 2B is a sectional view taken on line A-A in FIG. 2A.

In the embodiment, a microfluid chip 200 (which will also be hereinafter referred to simply as “chip 200”) into which a sample is poured is set in a sample analysis system 150. The microfluid chip 200 is set in the sample analysis system 150, whereby the poured sample liquid is handled by a physical action force from the outside of the chip and, for example, a plurality of target genes of monobasic polymorphism are inspected. Accordingly, for example, the target nucleic acid is amplified and is detected, whereby it is made possible to amplify and detect the target nucleic acid specific to the pathogen causing an infectious disease, and it is made possible to determine whether or not the pathogen exists in the sample, etc.

In the embodiment, the physical action force is a pneumatic action force (pneumatic drive force) generated by air supply or air suction from a plurality of ports 15 and 17 provided at the start point and the end point of a microchannel (which will also be hereinafter referred to simply as “channel”) 11 of the chip 200 shown in FIG. 2A. Therefore, it is made possible to perform move control of liquid supplied to the channel 11 to any desired position in the channel 11 by air supply or air suction acted on the start point and the end point of the channel.

The sample analysis system 150 is provided with basic components of a pump PMP using air as a working fluid, a valve SV, port connectors 19A and 19B that connects the pneumatic drive force from the pump PMP through the valve SV to the ports 15 and 17, a first heating section 21A of a first temperature regulation unit and a second heating section 21B of a second temperature regulation unit each of which heats a chamber part 35 of a reaction detection cell, a heat regulator 25, a fluorescence detection section 27 as a detection unit that detects the reaction state of liquid poured into the chamber part 35, a positioning mechanism 29 that positions the microfluid chip 200, and a control section 41 connected to the components for inputting a detection signal or sending a control signal, thereby controlling the sections containing the temperatures of the first heating section 21A and the second heating section 21B, as shown in FIGS. 1, 2A and 2B.

An intra-microchannel mixing apparatus 100 is made up of the first heating section 21A of the first temperature regulation unit, the second heating section 21B of the second temperature regulation unit, a temperature measuring section (not shown) placed on the periphery of the first heating section 21A and the second heating section 21B, and the control section 41.

The microfluid chip 200 is a plate member having an outer shape of 55×91 mm in length and width and 2 mm in thickness, for example, wherein a channel substrate 31 is formed with minute grooves and a lid 33 is put on the channel substrate 31 with an adhesive or a pressure sensitive adhesive, whereby the channel 11 is formed. The channel 11 has a plurality of reaction channels 34, chamber parts 35 of reaction detection cells each formed in a part of the corresponding reaction channel 34 and enlarged in cross section, a first channel 37 communicating with one end (upstream) of each of the reaction channels 34, and a second channel 39 communicating with an opposite end (downstream) of each of the reaction channels 34 are formed. The first channel 37 and the second channel 39 are common channels connected to the reaction channels 34 in common, so that treatment of liquid supply, discharge, etc., can be performed at the same time for the reaction channels 34. Accordingly, analytical processing can be speeded up and can be made efficient.

The channel substrate 31 is manufactured by injection molding of a thermoplastic high polymer. Although the high polymer to be used is not limited, it is desirable that the high polymer should be optically transparent, have high heat resistance, be chemically stable, and be easily injection molded; COP (cycloolefin polymer), COC (cycloolefin copolymer), PMMA (methyl methacrylate resin), etc., is preferred.

The expression “optically transparent” is used to mean that transmittance is high, scattering is small, and autofluorescence is small in the wavelengths of excitation light and fluorescence used for detection. Since the chip 200 has light-transmittancy for making it possible to detect fluorescence, for example, SYBR green is used for a detection reagent and it is made possible to measure fluorescence emitted as it is intercalated into double stranded DNA amplified by reaction. As the lid 33, a sheet-like high polymer which is optically transparent, has high heat resistance, and is chemically stable, for example, a PCR plate seal having a thickness of 100 μm is used (a pressure sensitive adhesive is applied to a plastic film).

A plurality of chamber parts 35 are provided in parallel and in each of the chamber parts 35, a first area 35A and a second area 35B are defined along the flowing direction of a liquid of a poured mixed substance. The first area 35A and the second area 35B are roughly equal in area and are contiguous with each other.

The first heating section 21A of the first temperature regulation unit is disposed on the bottom face of the first area 35A, and the second heating section 218 of the second temperature regulation unit is disposed on the bottom face of the second area 35B. The control section 41 regulates the heating amounts applied to the first heating section 21A and the second heating section 21B in response to the measurement temperature provided by the temperature measuring section (not shown) placed on the periphery of the first heating section 21A and the second heating section 21B and controls the liquid temperatures in the first area 35A and the second area 35B.

The first heating section 21A and the second heating section 21B may be any such as a resistance heating body other than a light emitting device of a halogen lamp, etc., to prevent disturbance of the fluorescence detection section 27.

The heat regulator 25 controls the temperatures of the first channel 37 and the second channel 39. In the embodiment, the heat regulator 25 is provided on both sides in the arrangement direction of the first heating section 21A and the second heating section 21B and may be left and right separate bodies in FIG. 2B, but may be provided so as to surround the first heating section 21A and the second heating section 21B. For example, a water-cooled heat sink, a Peltier device, etc., can be used as the heat regulator 25.

The DNA amplification reaction is kept at a temperature at which the activity of the used enzyme can be maintained constant by isothermal amplification reaction. The term “isothermal” mentioned here refers to such a roughly constant temperature at which an enzyme and a primer can function substantially. Further, the expression “roughly constant temperature” is used to mean that temperature change to such an extent that the substantial function of an enzyme and a primer is not impaired is allowed.

In the sample analysis system 150, while the liquid poured into the chamber part 35 is heated to any desired reaction temperature by the first heating section 21A and the second heating section 21B, the first channel 37 and the second channel 39 in contact with the liquid are set to the same temperature. Accordingly, if the first channel 37 and the second channel 39 differ in heat capacity because of the channel shape difference, etc., the internal pressures of the channels become the same.

The positioning mechanism 29 presses the microfluid chip 200 from above for making it possible to retain the microfluid chip 200. At this time, the first heating section 21A, the second heating section 21B, and the heat regulator 25 may be pressed elastically against the chip 200 with a spring mechanism (not shown), etc., so that the first heating section 21A, the second heating section 21B, and the heat regulator 25 come reliably in contact with the microfluid chip 200. To reliably transmit the heat of the first heating section 21A, the second heating section 21B, and the heat regulator 25 to the chip 200, preferably an elastic sheet material, etc., having good thermal conductivity is disposed on the top faces of the first heating section 21A, the second heating section 21B, and the heat regulator 25 so as to enhance adherence to the chip 200 (contact area).

Preferably, the heat regulator 25 controls the temperatures of liquid Lq1 at the end of the chamber part 35 in contact with the first channel 37 and liquid Lq2 at the end of the chamber part 35 in contact with the second channel 39. The liquids Lq1 and tq2 in the chamber part 35 in contact with the first channel 37 and the second channel 39 are regulated to the same temperature and thus heat is not transmitted from the liquid Lq in the chamber part 35 to the first channel 37 or the second channel 39 and the internal pressures of the first channel 37 and the second channel 39 become the same with higher accuracy. Accordingly, a move of liquid in the chamber part 35 can be suppressed more reliably.

Since the first heating section 21A, the second heating section 21B, and the heat regulator 25 are used for the reaction channels 34 in common, the temperature regulation conditions for the reaction channels 34 become the same and the analysis accuracy can be improved.

The fluorescence detection section 27 (see FIG. 1) is opposed to the chamber part 35, so that it does not come in direct contact with the chamber part 35 and liquid is not contaminated. The fluorescence detection section 27 measures fluorescence emitted as the liquid in the chamber part 35 excites. That is, double stranded DNA amplified by reaction in the chamber part 35 is intercalated, whereby it emits strong fluorescence. As the fluorescence intensity is measured, it is made possible to detect the presence or absence of a gene sequence as a target.

The chamber part 35 is excited at a wavelength of about 490 nm by the fluorescence detection section 27 and fluorescence of about 520 nm of intercalated SYBR green is measured, whereby amplification of the target DNA is recognized. Therefore, if a nucleic acid sequence as a target exists, an increase in the fluorescence intensity is recognized; if a nucleic acid sequence as a target does not exist, an increase in the fluorescence intensity is not recognized.

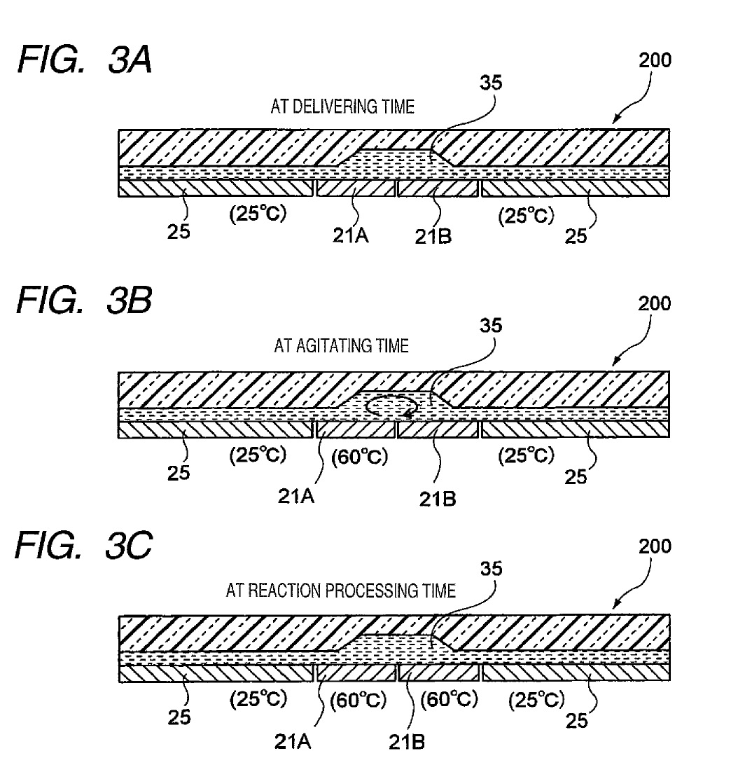

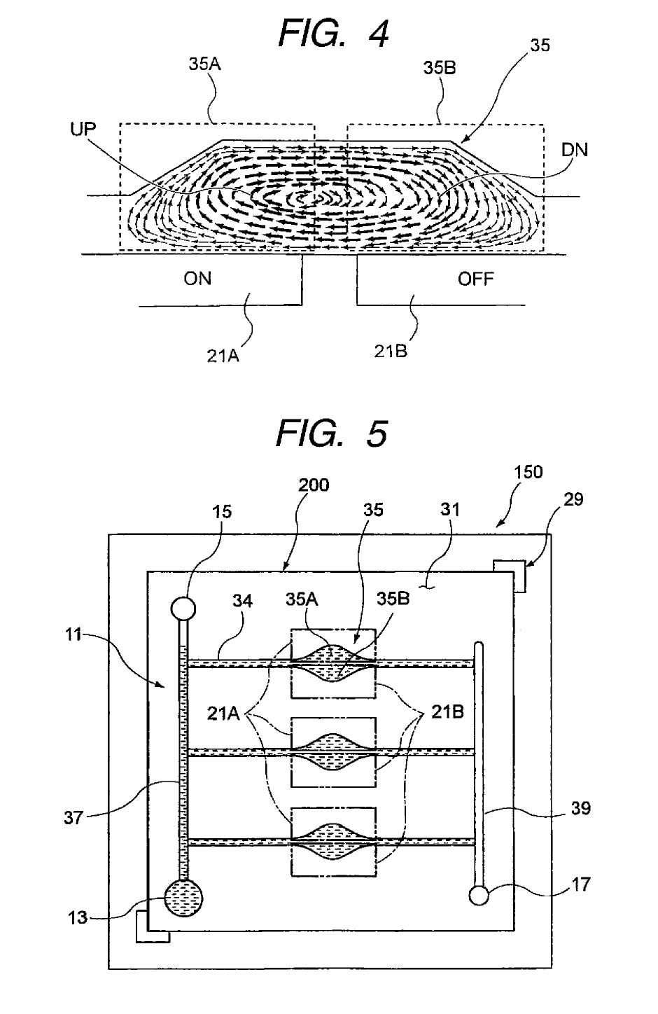

Next, a sample analysis method using the sample analysis system 150 and the microfluid chip 200 will be discussed. FIGS. 3A to 3C are sectional views taken on line A-A in FIG. 2A; FIG. 3A is a conceptual drawing to show a state at the liquid delivering time; FIG. 3B is a conceptual drawing to show a state at the agitating time; and FIG. 3C is a conceptual drawing to show a state at the reaction processing time. FIG. 4 is a main part enlarged view of FIG. 3B.

First, the microfluid chip 200 is positioned and held in the positioning mechanism 29 of the sample analysis system 150, as shown in FIGS. 1, 2A and 2B. In this state, the heat regulator 25 is regulated to the normal temperature (for example, 25° C.). Next, a predetermined quantity of reagent is entered through the port 13 and is introduced into the first channel 37.

When the reagent arrives at a place just before the port 15, the transport is stopped. Next, the pressure of the port connector 19B connected to the port 17 is reduced by the pump PMP and the reagent is introduced into the chamber part 35 as shown in FIG. 3A. Next, the port 17 is closed and the port connector 19A connected to the port 15 is pressurized by the pump PMP and the reagent remaining in the first channel 37 is pushed back to the port 13. Returning the reagent remaining in the first channel 37 can also be skipped.

Then, the first heating section 21A is regulated to a temperature, for example, 60° C. and the second heating section 21B is regulated to a temperature, for example, 25° C. For example, only the first heating section 21A may be set to a temperature of 60° C. and may be turned ON and the second heating section 21B may remain OFF. The temperature regulation is performed as the control section 41 performs feedback control of the heating amounts applied to the first heating section 21A and the second heating section 21B in response to the measurement temperature from the temperature measuring section (not shown) disposed on the periphery of the first heating section 21A and the second heating section 21B. Accordingly, the reagent positioned in the first area 35A in the chamber part 35 is heated to 60° C. and a local temperature difference occurs between the reagent positioned in the first area 35A and the reagent positioned in the second area 35B at about 25° C.

Then, convection at large speed occurs in the chamber part 35, as shown in FIGS. 3B and 4. That is, the specific gravity of the reagent heated to 60° C. lowers in the first area 35A and an upwelling current UP occurs and the low-temperature (25° C.) liquid reagent from the second area 35B flows into therebelow. Accordingly, a downwelling current DN occurs in the second area 35B and the liquid reagent rising in the first area 35A flows into the second area 35B as it circulates.

As described above, the liquid reagent is agitated by the convection forcibly caused to occur in the chamber part 35 and can be uniformly mixed efficiently in the narrow microfluid channel 11. Since the mixing is performed in the chamber part 35 having a comparatively large cross-sectional area, it is made possible to efficiently mix a round volume of liquid reagent at a time. Further, the liquid reagent is heated from the bottom face of the chamber part 35, whereby a flow from the bottom to the top can be made efficiently to occur in the chamber part 35. Accordingly, the agitating effect can be enhanced for efficiently mixing the liquid reagent uniformly.

To generate convection effective for mixing, preferably the temperature difference between the first area 35A and the second area 35B is set to at least 10° C. or more. According to the flow visualizing experiment result using fluorescence beads at convection speed when the temperature difference is set to 35° C. (60° C.-25° C.), convection at speed of about 260 μm/sec occurred and accordingly dissolving and mixing of the reaction reagent fixedly secured to the chamber part 35 were able to be completed in about one minute.

As the temperature difference between the first heating section 21A and the second heating section 21B is larger, faster convection can be generated. According to the fluorescence bead flow visualizing experiment result when the first heating section 21A and the second heating section 21B are set to the same temperature, the convection speed was roughly several 10 μm/sec and was about 1/10 of the convection speed when the temperature difference is 35° C.; efficient agitating was unable to be performed.

After completion of dissolving and mixing of the reaction reagent, the first heating section 21A and the second heating section 21B are regulated to a temperature required for a chemical reaction (for example, 60° C.) and the reaction is started. At this time, the first channel 37, the second channel 39, and both sides of the chamber part 35 of each reaction channel 34 are held at 25° C. and the chamber part 35 is held at 60° C. by the heat regulator 25, so that evaporation from both sides of the chamber part 35 is extremely small and the reagent in the chamber part 35 does not decrease.

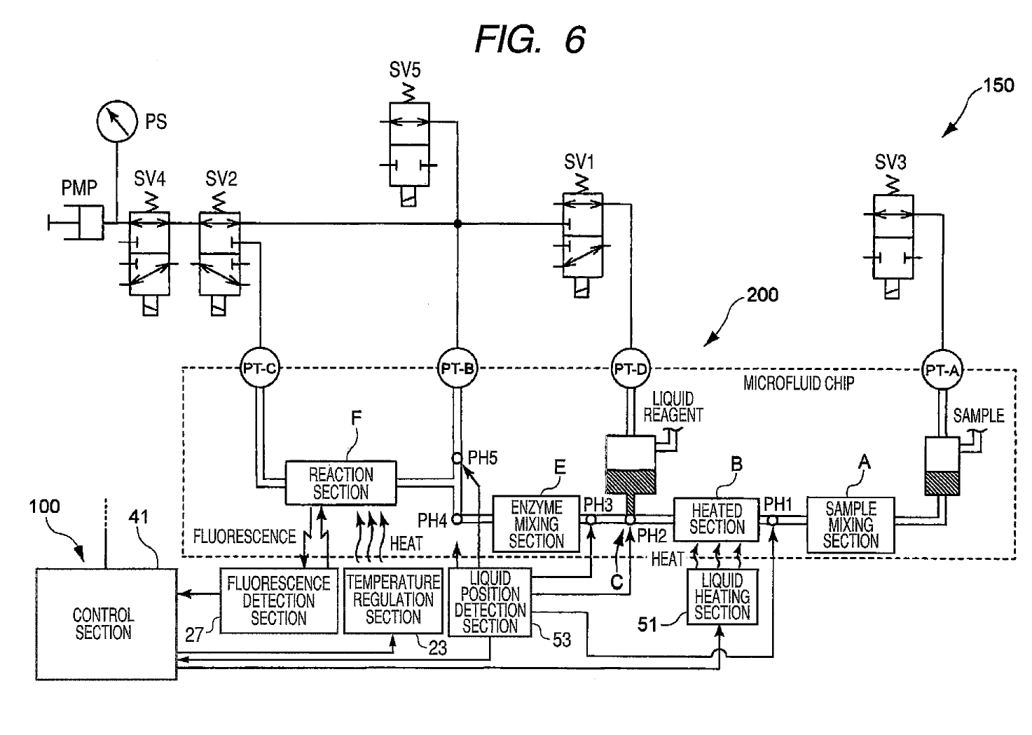

Another placement of the first heating section 21A and the second heating section 21B can also be adopted. FIG. 5 is a plan view of a microfluid chip retention section of another embodiment of the invention. As shown in FIG. 5, the first heating section 21A and the second heating section 21B may be placed so that they are divided in a direction crossing the flowing direction of liquid of mixed substance (in the embodiment shown in FIG. 5, in a direction at right angles to the flow direction of the reaction channel 34). Also in this case, the first area 35A and the second area 35B are roughly equal in area and are contiguous with each other. The first heating section 21A and the second heating section 21B are opposed to the first area 35A and the second area 35B.

In the description given above, the chamber part 35 is divided into two parts of the first area 35A and the second area 35B, but the number of divisions is not limited to it; the chamber part 35 can be divided into any number of parts if convection can be generated effectively.

### Second Embodiment

Next, a second embodiment of applying an intra-microchannel mixing apparatus according to the invention to a microfluid chip for analyzing a biosubstance of blood, etc., will be discussed with FIGS. 6 to 10.

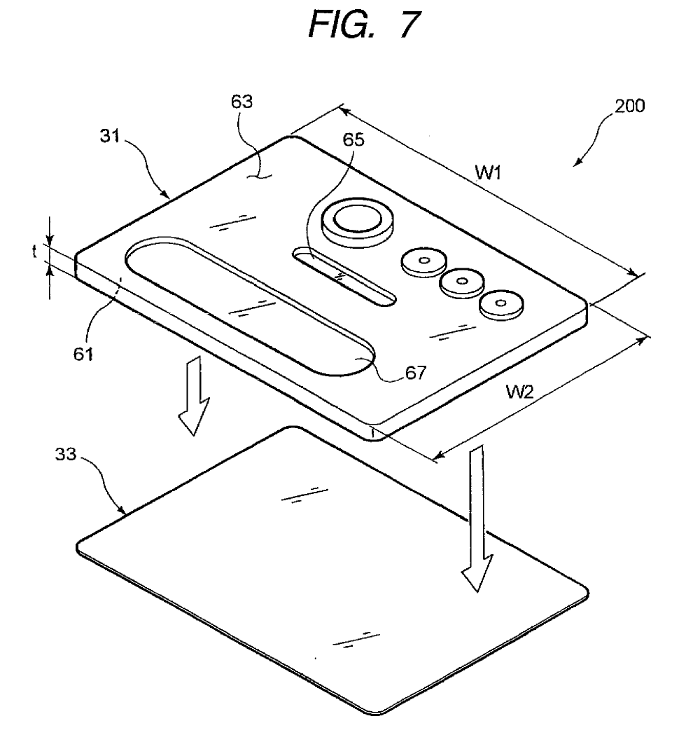

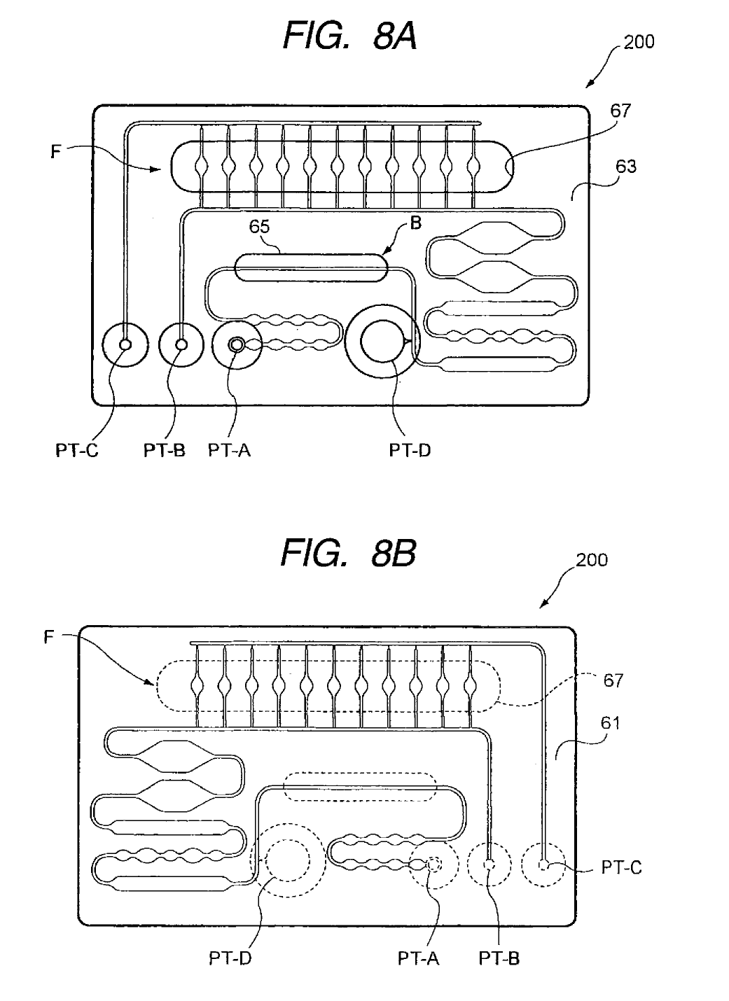

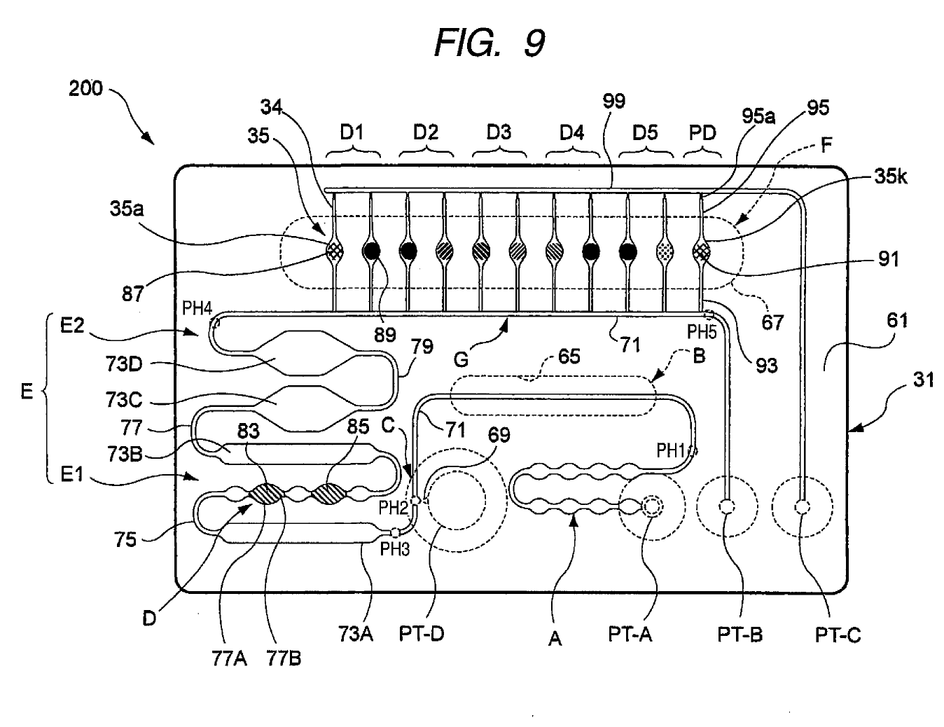

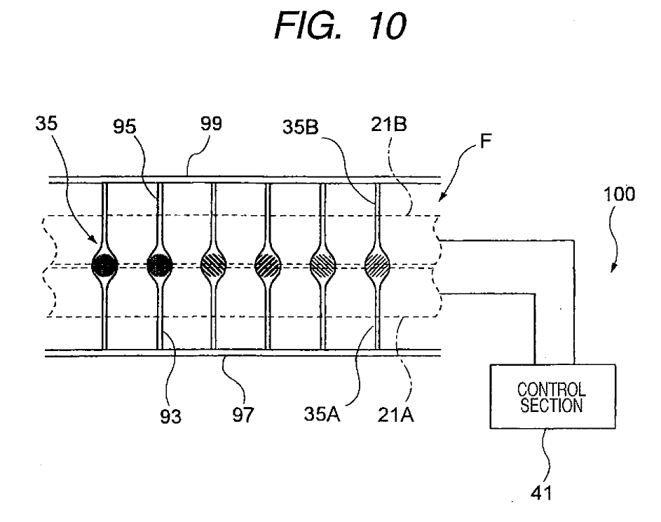

FIG. 6 is a block diagram to represent a microfluid chip of the second embodiment according to the invention together with the schematic configuration of a sample analysis system. FIG. 7 is an exploded perspective view of the microfluid chip shown in FIG. 6. FIGS. 8A and 8B are plan views of the microfluid chip shown in FIG. 7 wherein FIG. 8A is a top view and FIG. 8B is a bottom view. FIG. 9 is an enlarged view of FIG. 8B. FIG. 10 is an enlarged view of a reaction section in FIG. 9. Components identical with or similar to those of the first embodiment are denoted by the same or corresponding reference numerals in the second embodiment and will be briefly discussed or will not be discussed again.

A microfluid chip 200 of the second embodiment according to the invention is set in a sample analysis system 150 for use and is discarded after one use. In the embodiment, blood (whole blood) of a sample is poured into the microfluid chip 200. The microfluid chip 200 is set in the sample analysis system 150, whereby the sample liquid is handled by a physical action force from the outside of the chip and, for example, a plurality of target genes of monobasic polymorphism are inspected; reaction to amplify the nucleic acid of the target sequence isothermally and specifically and detection thereof as shown in Japanese Patent Laid-Open No. 2005-160381 can be realized on the microfluid chip 200. Accordingly, for example, the target nucleic acid is amplified and is detected, whereby it is made possible to amplify and detect the target nucleic acid specific to the pathogen causing an infectious disease, and it is made possible to determine whether or not the pathogen exists in the sample, etc.

The sample analysis system 150 includes basic components of a pump PMP using air as a working fluid, valves SV1, SV2, SV3, SV4, and SV5, a sample heating section 51, a temperature regulation section 23, a liquid position detection section 53, a fluorescence detection section 27, and a control section 41 connected to the components for inputting a detection signal or sending a control signal. An intra-microchannel mixing apparatus 100 includes the temperature regulation section 23 and the control section 41 and is built in as a part of the sample analysis system 150.

A pressure sensor PS is provided between the pump PMP and the valve SV4. The valve SV4 is intervened between the pump PMP and the valve SV2. The valves SV2, SV1, SV3, and SV5 are connected to a fourth port PT-C, a second port PT-D, a first port PT-A, and a third port PT-B, as shown in FIG. 6. The sample heating section 51 heats a heated section B of the chip 200, the temperature regulation section 23 performs temperature regulation of a reaction section F of the chip 200, and the fluorescence detection section 27 can detect fluorescence of the reaction section F. The temperature regulation section 23 includes a plurality of heating sections (first heating section 21A and second heating section 21B) that can be set to different temperatures by the control section 41, and the heating sections are disposed below the reaction section F. The operation of the components is described later in detail.

The microfluid chip 200 is made up of a channel substrate 31 and a lid 33 put on a lower face 61 of the channel substrate 31, as shown in FIG. 7. The channel substrate 31 is manufactured by injection molding of a thermoplastic high polymer. Although the high polymer to be used is not limited, it is desirable that the high polymer should be optically transparent, have high heat resistance, be chemically stable, and be easily injection molded; COP, COC, PMMA, etc., is preferred. The expression “optically transparent” is used to mean that permeability is high, scattering is small, and autofluorescence is small in the wavelengths of excitation light and fluorescence used for detection. Since the chip 200 has translucency for making it possible to detect fluorescence, for example, SYBR green is used for a detection reagent and it is made possible to measure fluorescence emitted as it is intercalated into double stranded DNA amplified by reaction. Accordingly, it is made possible to detect the presence or absence of a gene sequence as a target.

The channel substrate 31 is formed on an upper face 63 with excavations 65 and 67, which are positioned corresponding to the heated section B and the reaction section F. Openings communicating with the first port PT-A, the second port PT-D, the third port PT-B, and the fourth port PT-C are made in the lower face 61 of the channel substrate 31 as shown in FIG. 8B. The channel substrate 31 is formed, for example, as outer dimensions of 55×91 mm of length W2×width W1 and having a thickness t of about 2 mm.

The lid 33 is a member for lidding the ports, the cells, and the channels (grooves) formed on the channel face (lower face 61) of the channel substrate 31, and the lid 33 and the channel substrate 31 are joined with an adhesive or a pressure sensitive adhesive. A sheet-like high polymer which is optically transparent, has high heat resistance, and is chemically stable is used as the lid 33 like the channel substrate 31. In the embodiment, a PCR plate seal having a thickness of 100 μm is used (a pressure sensitive adhesive is applied to a plastic film).

The channel substrate 31 is formed with the ports, the cells, the channels, etc., for performing necessary operation on liquid (described later in detail). That is, the channel substrate 31 includes the first port PT-A for inputting sample liquid containing biological cells (nucleic acid) and a pretreatment reagent (first liquid), the second port PT-D for inputting a reaction amplification reagent (second liquid), the third port PT-B for supplying air pressure to the channel, the fourth port PT-C at the channel termination where pressure is reduced, a first channel (sample mixing section) A for mixing the sample liquid and the pretreatment reagent input from the first port PT-A to generate a first mixed liquid, a second channel (heated section) B for heating the first mixed liquid, extracting DNA from the biological cell, and decomposing the DNA into a single strand, a third channel (reagent merge section) C for allowing the reaction amplification reagent to merge with the first mixed liquid treated in the heated section B, a fourth channel (enzyme retention section) D solidifying and installing an enzyme (first solid) whose dissolution advances with the passage of the second mixed liquid merged in the reagent merge section C, a fifth channel (enzyme mixing section) E for promoting mixing of the enzyme into the second mixed liquid treated in the enzyme retention section D, a plurality of sixth channels (reaction section) F connected to the enzyme mixing section E for executing DNA amplification by dissolving and heating a primer (second solid) solidified and installed in the channel and detection of DNA amplification at the same position, and a seventh channel (fixed-quantity dispensing channel) G connected to the channel of the reaction section F for dispensing a fixed quantity of the second mixed liquid treated in the enzyme mixing section E to each of a plurality of reaction detection cells (chamber parts) 35 of the reaction section F, as shown in FIG. 9.

The first port PT-A, the second port PT-D, the third port PT-B, and the fourth port PT-C (port section PT) are made of holes piercing the top and bottom faces of the channel substrate 31 and the lid 33 is put thereon, whereby concave parts communicating with the channels are formed. Each port section PT is made a slightly thicker than any other portion of the channel substrate 31 and a liquid delivery port pad (not shown) of the sample analysis system 150 is connected thereto. Each port pad is connected via piping to the valves SV1, SV2, SV3, and SV4 (corresponding to the valve SV in FIG. 1, which will also be hereinafter referred simply as SV). The control section 19 can control the operation of the valves SV and the pump PMP, thereby placing the air of the port section PT in a reduced pressure state, a pressurization state, an atmospheric release state, or a hermetically sealed state and transporting droplets in the channel as desired.

Upon completion of any desired transport in the microfluid chip 200, the port pads are detached from the port sections PT and labels, etc., are put, whereby the microfluid chip 200 is placed in a hermetically sealed state. If amplification reaction is executed in a state in which the chip 200 is not hermetically sealed, there is the risk of allowing amplified DNA to flow out from the chip, polluting the environment, and causing carry over. To prevent this, the chip 200 is placed in the hermetically sealed state before amplification reaction.

The first port PT-A is used as a sample port and blood 1 μL and pretreatment reagent 3 μL are input thereto. The pretreatment reagent is used to isolate a nucleic acid component from leucocytes in blood. Chemical dissolving treatment is performed using a surface active agent or strong alkali. For example, a nonionic surface active agent, a cationic surface active agent, an anionic surface active agent, an ampholytic surface active agent, etc., can be named as the surface active agent. To prevent blood coagulation, an anticoagulant of heparin, EDTA, etc., may be added.

The second port PT-D is used as a liquid reagent port and a reaction amplification reagent (56 μL) is input thereto. The reaction amplification reagent contains a reagent required for amplification reaction and detection other than an enzyme, a primer. For example, a catalyst of magnesium chloride, magnesium acetate, magnesium sulfate, etc., a substrate of dNTP mix, etc., a buffer solution of a tris hydrochloride buffer, a tricine buffer, a sodium biphosphate buffer, a potassium dihydrogen phosphate buffer, etc., can be used. Further, an additive of dimethyl sulfoxide, betaine (N,N,N-trimethylglycine), etc., an acid substance, a cationic complex, etc., described in International Patent Publication No. 99/54455 pamphlet may be used.

SYBR green can be used as the detection reagent. SYBR green is intercalated into double stranded DNA amplified by reaction, whereby it emits strong fluorescence. The fluorescence intensity is measured, whereby the presence or absence of a gene sequence as a target is detected.

The third port PT-B and the fourth port PT-C are used as liquid delivery ports and are switched to a reduced pressure state, a pressurization state, an atmospheric release state, a closed sate by the pump PMP and the valve SV, thereby driving droplets in the channel.

As shown in FIG. 9, the sample mixing section A is a channel with a concatenation of tortoise shell-shaped cells larger than the whole amount of the blood and the pretreatment reagent input to the first port PT-A and the blood and the pretreatment reagent are allowed to pass through the channel, whereby the blood and the pretreatment reagent input to the first port PT-A are mixed uniformly. That is, the channel of the sample mixing section A is formed with an alternating pattern of a wide channel part with the cross-sectional area in an orthogonal direction to the flowing direction of liquid being larger than the cross-sectional area in any other channel and a narrow channel part having a smaller cross-sectional area than the wide channel part. Therefore, when the blood input to the first port PT-A reaches the sample mixing section A, the blood and the pretreatment reagent pass through the channel formed with the alternating pattern of the wide channel parts and the narrow channel parts along the liquid flowing direction, whereby agitation of orifice effect is performed more than once and the blood and the pretreatment reagent are mixed uniformly.

The heated section B is heated to 98° C. by the sample heating section 51 shown in FIG. 6. That is, in the microfluid chip 200, the control operation condition of liquid treatment becomes a condition containing the heating setup temperature to perform heating treatment of liquid in a liquid treatment section. For example, in nucleic acid amplification reaction according to a PCR (Polymerase Chain Reaction) method, temperature regulation of a reaction liquid of a mixture of template DNA, a primer, a substrate, a heat resistant polymerase enzyme, etc., is performed by liquid delivery control in the liquid channel and the reaction liquid is changed to three predetermined types of temperatures in sequence repeatedly, so that it is made possible to amplify the target DNA. In the embodiment, the blood and the pretreatment reagent pass through the portion, whereby two strands of DNA extracted from leucocytes with the pretreatment reagent become one strand. To heat the heated section B uniformly, the channel substrate 31 is provided with the excavation 65 and this portion is thinned to about 1.2 mm.

The reagent merge section C makes the reaction amplification reagent merge with the blood and the pretreatment reagent subjected to the heating treatment. The magnitude relation of capillary forces of channels in the second port PT-D is port D exit channel 69>main channel 71>port D channel (second port PT-D) and a Laplace pressure valve is formed in the connection part of the port D exit channel 69 and the main channel 71. The reaction amplification reagent input to the second port PT-D remains on the connection face of the port D exit channel 69 and the main channel 71 without flowing out to the main channel 71. When the mixed liquid of the blood and the pretreatment reagent arrives at the port D exit channel 69 as operation described later is performed, the Laplace pressure valve is destroyed and the two liquids mentioned above merge.

The enzyme mixing section E has a first mixing section E1 and a second mixing section E2 placed in order from the second port PT-D as shown in FIG. 9. The first mixing section E1 and the second mixing section E2 are connected by a second channel 77 part of a connection channel.

In the first mixing section E1, a first channel part 73A having a larger vertical cross-sectional area in the flowing direction of liquid than the vertical cross-sectional area in any other channel and a second channel part 75 having a smaller vertical cross-sectional area than the first channel part 73A for connecting the first channel parts 73A are placed in series. That is, from the upstream side, the first channel part 73A at the preceding stage, the second channel part 75, first channel part 73C at the following stage, and the second channel part 77 of the connection channel are placed in order.

In the second mixing section E2, a first channel part 73C having a larger vertical cross-sectional area in the flowing direction of liquid than the vertical cross-sectional area in any other channel and a second channel part 79 having a smaller vertical cross-sectional area than the first channel part 73C for connecting the first channel parts 73C are placed in series. That is, from the upstream side, the first channel parts 73C at the preceding stage, the second channel part 77, and first channel part 73D at the following stage are placed in order.

The first channel parts of each of the first mixing section E1 and the second mixing section E2 include at least two first channel parts. In the example shown in the figure, two first channel parts are provided, but the number of the first channel parts is not limited to two and a larger number of first channel parts and second channel parts may be provided.

The vertical cross-sectional area of the first channel part 73A, 73B in the first mixing section E1 is formed smaller than the vertical cross-sectional area of the first channel part 73C, 73D in the second mixing section E2. In the embodiment, the depths in the mixing sections (vertical direction depth to the plane of FIG. 9) are made the same and the width of the first channel part 73A, 73B is formed smaller than the width of the first channel part 73C, 73D. The channel direction length of the first channel part 73A, 73B in the first mixing section E1 is formed longer than the channel direction length of the first channel part 73C, 73D in the second mixing section E2. In the embodiment, the first channel parts 73A, 73B, 73C, and 73D are formed in parallel and the second channel parts 79 and 81 are formed so as to join the first channel parts, but the placement is not limited to it; any desired placement may be adopted.

Thus, the enzyme mixing section E according to the embodiment has the first mixing section E1 provided preceding the second mixing section E2. The first mixing section E1 is made elongated, so that when two or tore types of liquids different in wettability are accommodated in the channel in an unmixed state, if a liquid component having high wettability is adhered and remains on the channel face, leaning to one side from the channel center, of a meniscus curved surface liquid end formed because of the wettability difference is decreased. Accordingly, occurrence of air bubbles in the mixing section can be prevented.

That is, according to the configuration, two or more types of liquids are preliminarily mixed in the first mixing section E1 wherein a difference is hard to occur in the advance degree of a meniscus curved surface liquid end. Accordingly, the difference in the advance degree of a meniscus curved surface liquid end, caused as the liquids different in wettability come in contact with the channel face is suppressed in the second mixing section E2 having high mixing performance.

Preferably, the volume of each of the first channel part 73A at the preceding stage and the first channel part 73B at the following stage is set to a volume capable of accommodating the whole of one liquid delivered from the second port PT-D and preferably the volume is 80% or more of the volume of the whole delivered liquid. Accordingly, in the first mixing section E1, the whole liquid is accommodated in the first channel part 73A at the preceding stage and then the liquid passes through the second channel part 75 at the preceding stage and is accommodated in the first channel part 73B at the following stage and is allowed to pass through the wide and narrow channel parts alternately, whereby the liquid is agitated more than once by the orifice effect and mixing of two or more types of liquids can be promoted.

The enzyme retention section D is placed in the second channel part 75 between the first channel parts 73A and 73B. Like the mixing section A, the enzyme retention section D is implemented as a channel formed with an alternating pattern of a wide channel part 77A and a narrow channel part 77B along the liquid flowing direction. Some of the wide channel parts 77A become reagent retention cells for retaining a reagent 83 dried and solidified by freezing and drying after a water solution of polymerase and dextrin is put as a drip and a reagent 85 dried and solidified by freezing and drying after a water solution of MutS and dextrin is put as a drip.

The enzyme mixing section E causes the merge liquid of the blood, the pretreatment liquid, and the reaction amplification reagent to go and return between the first channel parts 73A and 73B of the first mixing section E1, thereby dissolving the reagent 83 of a first enzyme and the reagent 85 of a second enzyme and mixing the merge liquid.

The meniscus refers to a curved surface produced as the center of a liquid in a narrow channel swells or lowers as compared with a portion along the surface in the channel and is caused to occur by a capillary action. The capillary action is a phenomenon in which a liquid in a narrow channel attempts to flow along the channel; the degree is proportional to the surface tension of the liquid and is inversely proportional to the cross-section area of the channel. The surface tension is a force that the surface of a liquid shrinks and takes an area as small as possible, and works along the surface.

In the microfluid chip 200, as in the embodiment, if liquids different in wettability are mixed, they are preliminarily mixed in the first mixing section E1, whereby the difference in the advance degree of the meniscus curved surface liquid end is suppressed in the second mixing section E2 having high mixing performance at the following stage. Particularly, if the liquids are blood and a diluent, the blood and the diluent are reliably preliminarily mixed in the first mixing section E1, whereby the difference in the advance degree of the meniscus curved surface liquid end is suppressed in the second mixing section E2 having high mixing performance, occurrence of a liquid-unfilled part is prevented, and uniform dilution of blood is made possible.

In the example shown in the figure, the mixing sections E1 and E2 are provided each with two first channel parts, but the number of the first channel parts is not limited to two and a larger number of first channel parts may be formed alternately with the second channel part.

The channels upstream and downstream from the wide channel part 77A of the enzyme retention section D retaining the reagent 83, 85 are thinner than the retention section for preventing the solidified reagent 83, 85 from peeling off and flowing out to the preceding or following channel due to vibration of retention, transport, etc., of the chip 200 if there is no adhesion of the dried and solidified reagent 83, 85 to the channel.

Polymerase of the reagent 83 may be polymerase having strand displacement activity (strand displacement capability) and any polymerase of normal temperature property, moderate temperature property, or heat resistance property can be used preferably. Polymerase may be a natural body or may be a variant provided by artificially varying the natural body. As such polymerase, DNA polymerase can be named. Further, preferably the DNA polymerase has substantially no 5′→3′ exonuclease activity. As such DNA polymerase, a variant losing 5′→3′ exonuclease activity of DNA polymerase derived from thermophile Bacillus bacteria such as Bacillus stearothermophilus (which will be hereinafter called B. st) or Bacillus caldotenax (which will be hereinafter called B. ca), Klenow fragment of DNA polymerase I derived from Escherichia coli (E. coli), etc., can be named.

Dextrin is used as an enzyme stabilizing agent, whereby it is made possible to preserve enzymes for a long period of time and the enzyme in reaction liquid is also stabilized in amplification reaction and thus it is made possible to increase the amplification efficiency of nucleic acid. As other enzyme stabilizing agents, glycerol, bovine serum albumin, saccharides, etc., can be used.

The reagent 85 is placed downstream from the reagent 83 and is a reagent dried and solidified by freezing and drying after a water solution of MutS and dextrin is put as a drip. MutS is one of protein groups called “mismatch binding protein” (also called “mismatch recognition protein”). When a partial mismatch base pair in two strands of DNA occurs, MutS is a protein group having a function of recovering it. In addition to the MutS protein (International Patent Publication No. 9-504939), various mismatch binding proteins such as MutM protein (Japanese Patent Laid-Open No. 2000-300265) are known.

The enzyme mixing section E causes the merge liquid of the blood, the pretreatment liquid, and the reaction amplification reagent to go and return between the first channel parts 73A and 73B of the first mixing section E1, thereby dissolving the reagent 83 and the reagent 85 and preliminarily mixing the merge liquid. At the same time, air bubbles in the channel are eliminated. Further, the merge liquid is caused to go and return between the first channel parts 73C and 73D of the second mixing section E2, thereby mixing the merge liquid uniformly as full-scale mixing. To stably transport so that a droplet does not involve air bubbles at the going and returning time, it is desirable that the enzyme mixing section E should be water repellent for the mixed liquid; in the embodiment, COP (contact angle of water is about 110°) is selected as the material of the channel substrate 31.

In the reaction section F, a water solution of a primer and gelatin of the target DNA is put as a drip and then is cooled, solidified, and fixed. The primer is oligonucleotide of about 20 base length having a complementary base sequence in a specific portion of the target DNA and becomes a staring point (origin) of DNA synthesis of polymerase. In the embodiment, 11 reaction detection cells 35a to 35k are formed and to perform amplification reaction specifically for sequence of wild and mutant for the gene to be inspected, a primer 87 for amplifying wild and a primer 89 for amplifying mutant are paired and are fixed to different reaction detection cells.

That is, genes at five places D1 to D5 are to be inspected in the 10 reaction detection cells 35a to 35j. A primer 91 for amplifying a gene sequence where polymorphism does not exist is fixed in the reaction detection cell 35k at the remaining PD and this cell is used as positive control. The sample mixed in the first mixing section E1 and the second mixing section E2 is dispensed to the reaction detection cells 35a to 35k in a fixed quantity.

As shown in FIG. 10, each chamber part 35 includes a first area 35A (upstream) and a second area 35B (downstream) defined as it is divided into two upstream and downstream parts along the flowing direction of a sample. The first area 35A and the second area 35B are roughly equal in area. The first heating section 21A is disposed on the bottom face of the first area 35A, and the second heating section 21B is disposed on the bottom face of the second area 35B; the first heating section 21A and the second heating section 21B can be set in different temperatures by the control section 41.

If the first heating section 21A is set to a temperature of 60° C., for example, and the second heating section 21B is set to a temperature of 25° C., for example, a local temperature difference occurs in the liquid in each chamber part 35 and convection at large speed occurs in the chamber part 35 (see FIG. 4). Accordingly, the liquid in each chamber part 35 is forcibly agitated, so that gelatin fixed to the reaction section F dissolves and the primer of the target DNA disperses in each chamber part 35 and is mixed uniformly.

The water solution of the primer and gelatin is put as a drip and is fixed to the cell on the side of the channel substrate 31 and is placed on the upper face of the channel in a microchip use state. After liquid flows in, it is heated from the lid 33 side, namely, the lower face, whereby gelatin ge containing the primer 87 dissolved with temperature rise of the liquid flows to the lower side in the channel by gravity because the specific gravity of the gelatin is large. The liquid is heated to different temperatures in the first area 35A and the second area 35B from the lower face, whereby convection in the cell is promoted. The primer 87 and the gelatin ge are mixed and dispersed uniformly in a short time in the chamber part 35 because of the multiplier effect of the flow to the lower side of the channel caused by the gravity of the gelatin ge and the convection caused by heating the liquid.

Next, as shown in FIG. 9, both the first heating section 21A and the second heating section 21B are regulated to a temperature of 60° C. and the reaction detection cells 35 are heated, whereby solidified gelatin dissolves and is dispersed in the reaction detection cells 35 and isothermal amplification reaction is performed. Only a water solution of primer can be put as a drip on the reaction detection cells 35 and be dried and solidified. In this case, however, when liquid flows into the chamber part, the primer is allowed to flow in the flow direction and reaction, detection in the chamber part cannot be executed. Thus, gelatin hard to dissolve in a normal-temperature water solution is contained 0.5% and is put as a drip and is solidified.

A reaction detection cell entrance channel 93 and a reaction detection cell exit channel 95 are placed before and after each of the chamber parts 35 and each of the entrance and exit channels 93 and 95 is a narrow channel. The end face of the liquid after dispensing remains on the connection face of the entrance channel 93 and a main channel 71 and on the connection face of the exit channel 95 and an exhaust channel 99.

In the reaction section F wherein the heating section 21 (21A, 21B) is disposed, for the heating section 21 to heat uniformly, the channel substrate 31 is thinned to about 1.2 mm in the presence of the excavation 67. The heating section 21 is placed so as to heat the whole chamber parts 35 and parts of the entrance and exit channels 93 and 95, and the temperature of any other portion than the heating section 21 is regulated by another temperature regulation unit. That is, both end faces of the liquid in each reaction detection cell 35 are kept at the normal temperature without being heated. Accordingly, heating can be prevented from evaporating a water content. The heating section 21 (first heating section 21A and second heating section 21B) and the temperature regulation unit (temperature measuring section) on the periphery thereof make up the heat regulation section 23 in FIG. 6.

The entrance and exit channels 93 and 95, the main channel 71, and the exhaust channel 99 make up the fixed-quantity dispensing channel G. The fixed-quantity dispensing channel G dispenses a fixed quantity of the second mixed liquid treated in the enzyme mixing section E to a plurality of the chamber parts 35 of the reaction section F.

The liquid dispensed in a fixed quantity to the chamber parts 35 contains the sample liquid having biological cells, the pretreatment reagent, and the reaction amplification reagent. The primers 87, 89, . . . of pieces or fragments of nucleic acid are installed in each chamber part 35 and a fixed quantity of liquid is dispensed to the chamber part 35 and while the liquid is heated, excitation light is applied, whereby fluorescence occurring in the liquid treatment section is detected. Nucleic acid amplification reaction of the detected substance is conducted in the reaction detection cell 35. At this time, a labeled substance having a specific interaction carrying a photogenic substance of a label substance having high detection sensitivity, for example, a labeled antibody, a labeled antigen, a labeled nucleic acid, or the like is used. SYBR green is intercalated into double stranded DNA amplified by reaction, whereby it emits strong fluorescence. The fluorescence intensity is measured, whereby it is made possible to detect the presence or absence of a gene sequence as a target.

Each of the reaction detection cells 35a to 35k is excited at a wavelength of about 490 nm by an optical system and fluorescence of about 520 nm of intercalated SYBR green is measured, whereby amplification of the target DNA is recognized. That is, if a nucleic acid sequence as a target exists, an increase in the fluorescence intensity is recognized; if a nucleic acid sequence as a target does not exist, an increase in the fluorescence intensity is not recognized.

In the reaction section F, to make it possible to allow liquid to smoothly enter at the dispensing time to the reaction detection cells 35a to 35k and stably stop with the Laplace pressure valve at the exit, it is desirable that the reaction detection cells 35 and the narrow entrance and exit channels 93 and 95 placed before and after the reaction detection cells 35 should be hydrophilic in moderation. In the embodiment, at least the entrance and exit channels 93 and 95 are made hydrophilic by plasma irradiation (contact angle of water is about 70°).

As a method of making the channel substrate 31 partially hydrophilic or water-repellent, a known method (a method of applying hydrophilic/water repellent treatment liquid, a method of forming a thin film of hydrophilic/water repellent material by UV irradiation, vapor deposition, or sputtering, a method of molding using resins different in wettability by two-color molding or insert molding, or the like) can be used in addition to plasma irradiation. In the embodiment, the inner faces of the channels (at least the entrance and exit channels 93 and 95) have wettability of at least two levels or more. Accordingly, it is made possible to allow liquid to smoothly enter at the dispensing time to the reaction detection cells 35a to 35k and stably stop with the Laplace pressure valve at the exit.

The microfluid chip 200 according to the embodiment having the configuration described above includes:
(1) the first port PT-A for inputting sample liquid and a pretreatment reagent;
(2) the second port PT-D for inputting a reaction amplification reagent;
(3) the third port PT-B for supplying air pressure to the channel;
(4) the sample mixing section A for mixing the sample liquid and the pretreatment reagent input from the first port PT-A to generate a first mixed liquid;
(5) the heated section B for heating the first mixed liquid, extracting DNA from the biological cell, and decomposing the DNA into a single strand;
(6) the reagent merge section C for allowing the reaction amplification reagent to merge with the first mixed liquid treated in the heated section B;
(7) the enzyme retention section D solidifying and installing an enzyme whose dissolution advances with the passage of a second mixed liquid merged in the reagent merge section C;
(8) the enzyme mixing section E for promoting mixing of the enzyme into the second mixed liquid treated in the enzyme retention section D;
(9) the reaction section F made up of a plurality of reaction detection cells 35 connected to the enzyme mixing section E for executing DNA amplification by dissolving and heating a primer solidified and installed in the channel and detection of DNA amplification at the same position; and
(10) the fixed-quantity dispensing channel G connected to the plurality of reaction detection cells 35 for dispensing a fixed quantity of the second mixed liquid treated in the enzyme mixing section E to each of the plurality of reaction detection cells 35. Thus, complicated liquid delivery control can be performed according to the simple structure without requiring a stereoscopically complicated structure, the need for intricate operation of operation of pipetting, taking out from, taking to the device, etc., is eliminated, and the precise and highly reliable analysis result can be provided at a low cost and in a short time by performing simple operation requiring no skill.

Next, a liquid delivery flow using the microfluid chip 200 described above will be discussed.

As shown in FIG. 9, first a reaction amplification reagent is input to the second port PT-D. Since a Laplace pressure valve is formed in the connection part of the port D exit channel 69 of the second port PT-D and the main channel 71, the reaction amplification reagent does not flow out to the main channel 71. Next, blood and a pretreatment reagent are input to the first port PT-A and when the chip 200 is set in the sample analysis system 150 and analysis is started, the pressure of the third port PT-B is reduced and the blood and the pretreatment reagent pass through the sample mixing section A at high speed, whereby they are mixed uniformly.

When the liquid arrives at the sensing position PH1 and a sensor PH-1 of the liquid position detection section detects the liquid, the third port PT-B is pressurized and delivers a fixed quantity of the liquid toward the downward direction. Then, the pressure of the third port PT-B is reduced and delivers a fixed quantity of the liquid toward the upward direction. The liquid is more uniformly mixed by performing the reciprocating operation.

Next, when the liquid is allowed to pass through the heated section B at low speed, the mixed liquid of the blood and the pretreatment reagent is heated to 98° C. for a given time (for example, 15 seconds), and DNA in leucocytes is extracted, resulting in one strand. When the liquid arrives at the sensing position PH2, the reaction amplification reagent flows out from the second port PT-D to the main channel 71 by suction from the third port PT-B and merges with the mixed liquid of the blood and the pretreatment reagent without containing any bubbles.

Then, the liquid arriving at the sensing position PH3 is mixed in the first mixing section E1 and passes through the first channel part 73A and the enzyme retention section D and the enzyme is dissolved and the liquid is mixed in the first channel part 73B. Next, the mixed liquid is returned to the first channel part 73A and minute air bubbles occurring at the enzyme dissolving time leaves the liquid and is adhered on the channel wall and bursts and disappears. The mixed liquid is again returned to the first channel part 73B and is mixed. Similar reciprocating operation is also performed in the second mixing section E2 at the following stage, whereby the liquid is uniformly mixed. That is, the mixed liquid is transported from the first channel part 73B of the first mixing section E1 to the first channel part 73C of the second mixing section E2 and further is sent to the first channel part 73D and is returned from the first channel part 73D to the first channel part 73C.

Next, when the mixed liquid in the second channel part 73D of the second mixing section E2 is transported to the channel of the reaction section F and arrives at the sensing position PH5 by suction from the third port PT-B, it is sucked from the fourth port PT-C. Accordingly, the mixed liquid is transported into the reaction detection cell 35 and stops at a small-diameter part 95a of the reaction detection cell exit channel 95 downstream from the cell. As the stop timing, when the pressure sensor PS reaches a given pressure, it can be determined that dispensing to the reaction detection cell 35 is complete. At this time, each reaction detection cell 35 is kept at the normal temperature and the primer previously immobilized with gelatin is retained in the cell without dissolving. A label is put on each of the ports PT-A, PT-B, PT-C, and PT-D with a seal device (not shown) and the chip 200 is placed in the hermetically sealed state; the fear of allowing the amplified product by the amplification reaction to flow out from the chip, polluting the environment is eliminated.

Next, the first heating section 21A disposed on the lower face of the first area 35A of the reaction section F is heated to 60° C. and the second heating section 21B disposed on the lower face of the second area 35B is heated to 25° C., whereby a local temperature difference is caused to occur in the liquid in each of the reaction detection cells 35a to 35k and convection at large speed is caused to occur in the reaction detection cells 35a to 35k. Accordingly, the liquid in each of the reaction detection cells 35a to 35k is forcibly agitated, gelatin fixed to the reaction section F dissolves, and the primer of the target DNA disperses in each of the reaction detection cells 35a to 35k and is mixed uniformly.

Then, if the control section 41 rapidly heats both the first heating section 21A and the second heating section 21B to 60° C., the primer solidified by gelatin diffuses uniformly in the reaction detection cell 35 and isothermal amplification reaction starts. At this time, the liquid end faces of the narrow reaction detection cell entrance channel 93 and the narrow reaction detection cell exit channel 95 at both ends of the reaction detection cell 35 are not heated to 60° C. and are kept at the normal temperature and the liquid in the reaction detection cell 35 does not evaporate.

The reaction detection cells 35a to 35k are irradiated with excitation light in the fluorescence detection section 27 shown in FIG. 6 and fluorescence measurement is conducted at given time intervals, whereby whether or not the target gene sequence corresponding to the primer previously installed in each of the reaction detection cells 35a to 35k exists can be known. If the target gene sequence exists, it is recognized that the fluorescence intensity grows; whereas, if the target gene sequence does not exist, the fluorescence intensity does not grow.

Therefore, the microfluid chip 200 according to the invention includes channels for mixing with various reagents and dispensing a fixed quantity of the mixed liquid as constituent elements in addition to the first port PT-A for inputting sample liquid and a pretreatment reagent, the second port PT-D for inputting a reaction amplification reagent, and the third port PT-B for supplying air pressure to the channel, detects at least either the leading end or the trailing end of liquid in the liquid channel, and determines the control operation condition of the liquid in response to the end detection timing, whereby it is made possible to perform complicated handling of limited liquid by pneumatic drive from the outside of the chip 200 particularly with simple channels not containing any active valve or pump. This means that liquid delivery control is made possible according to a simple structure without requiring a stereoscopically complicated structure. Accordingly, simply by inputting a sample and a liquid reagent, automatically any desired droplet operation and chemical reaction are conducted and the need for intricate operation of operation of pipetting, taking out from, taking to the device, etc., is eliminated and the high analysis result can be obtained.

According to the intra-microchannel mixing method of the invention, the first area and the second area contiguous with each other are regulated to different temperatures, whereby convection is forcibly caused to occur in the mixed substances between the first area and the second area for agitating the mixed substances, and the mixed substances can be uniformly mixed efficiently in a short time in the narrow microchannel.

According to the intra-microchannel mixing apparatus of the invention, the control unit sets the first temperature regulation unit for regulating the temperature of the first area and the second temperature regulation unit for regulating the temperature of the second area to different temperatures, whereby convection can be caused to occur in the mixed substances efficiently between the first area and the second area, whereby the agitating effect of the mixed substances can be improved and the mixed substances can be uniformly mixed efficiently in the narrow microchannel. If the intra-microchannel mixing apparatus is applied to the mixing treatment in the microfluid chip, analytical processing in the microfluid chip can be speeded up and the accuracy of the analytical processing can be improved.

The intra-microchannel mixing apparatus according to the invention is not limited to the specific embodiments described above and modifications, improvement, etc., can be made as required.

In the intra-microchannel mixing method and apparatus according to the invention, the control unit sets the first temperature regulation unit for regulating the temperature of the first area and the second temperature regulation unit for regulating the temperature of the second area to different temperatures, whereby convection can be caused to occur in the mixed substances efficiently between the first area and the second area, whereby the agitating effect of the mixed substances can be improved and the mixed substances can be uniformly mixed efficiently in the narrow microchannel. If the intra-microchannel mixing method and apparatus are applied to the mixing treatment in the microfluid chip, analysis processing in the microfluid chip can be speeded up and the accuracy of the analysis processing can be improved.

The entire disclosure of each and every foreign patent application from which the benefit of foreign priority has been claimed in the present application is incorporated herein by reference, as if fully set forth.

What is claimed is:

1. An intra-microchannel mixing method for mixing at least two substances in a microchannel including: at least one minute channel; and a first area and a second area which are contiguous with each other, the method comprising:
accommodating the at least two substances in the at least one minute channel; and
regulating the first area and the second area to different temperatures.

2. The intra-microchannel mixing method according to claim 1,
wherein the at least one minute channel has at least one chamber part having an enlarged cross-sectional area compared with that of the at least one minute channel, and
the at least two substances are mixed in the at least one chamber part.

3. The intra-microchannel mixing method according to claim 2,
wherein the first area and the second area are areas each constitutes a bottom face of the at least one chamber part, and
a temperature of the at least two substances in the at least one chamber part is regulated from the bottom face.

4. The intra-microchannel mixing method according to claim 1,
wherein the microchannel includes: a plurality of the minute channels; and a common channel communicating with one end of each of the plurality of the minute channels, and
wherein the at least two substances are supplied from the common channel to each of the plurality of the minute channels.

5. An intra-microchannel mixing apparatus for mixing at least two substances in a microchannel, the apparatus comprising:
a microchannel that includes: at least one minute channel; and a first area and a second area which are contiguous with each other;
a first temperature regulation unit that regulates a temperature of the first area;
a second temperature regulation unit that regulates a temperature of the second area; and
a control unit that is capable of setting the first temperature regulation unit and the second temperature regulation unit to different temperatures.

6. The intra-microchannel mixing apparatus according to claim 5,
wherein the at least one minute channel has at least one chamber part having an enlarged cross-sectional area compared with that of the at least one minute channel, and
the at least two substances are mixed in the at least one chamber part, and
wherein the first temperature regulation unit and the second temperature regulation unit are placed facing the at least one chamber part.

7. The intra-microchannel mixing apparatus according to claim 5,
wherein the first area and the second area are roughly equal in area.

8. The intra-microchannel mixing apparatus according to claim 5,
wherein the first temperature regulation unit and the second temperature regulation unit each comprises:
a heating section that heats the at least one minute channel; and
a temperature measuring section that measures a temperature of the at least one minute channel,
wherein a heating amount of the heating section is regulated in response to a measurement temperature by the temperature measuring section.

9. The intra-microchannel mixing apparatus according to claim 5,
wherein the microchannel includes: a plurality of the minute channels; and a common channel communicating with one end of each of the plurality of the minute channels, and
wherein the at least two substances are supplied from the common channel to each of the plurality of the minute channels.

10. The intra-microchannel mixing apparatus according to claim 5,
wherein the at least two substances contain: a liquid reagent; and a soluble solid, and
the soluble solid is previously fixed in an inside of the microchannel.
